(19) United States
(12) Patent Application Publication
(10) Pub. No.: US 2017/0022823 A1
(43) Pub. Date: Jan. 26, 2017

(54) TURBINE ROTORS INCLUDING TURBINE BLADES HAVING TURBULATOR-COOLED TIP POCKETS

(71) Applicant: United Technologies Corporation, Hartford, CT (US)

(72) Inventors: EDWARD F. PIETRASZKIEWICZ, Southington, CT (US); BRANDON W. SPANGLER, Vernon, CT (US)

(73) Assignee: UNITED TECHNOLOGIES CORPORATION, Hartford, CT (US)

(21) Appl. No.: 14/807,683

(22) Filed: Jul. 23, 2015

(51) Int. Cl. F01D 5/20; F01D 5/02; F01D 5/18

(52) U.S. Cl. CPC F01D 5/20; F01D 5/18; F01D 5/02; F05D 2220/32; F05D 2240/307; F05D 2260/2212; F05D 2260/22141

(57) ABSTRACT

A turbine blade is provided. The turbine blade includes a suction side wall including a first tip edge, a pressure side wall opposite the suction side wall and including a second tip edge. A tip wall extends between the suction side wall and the pressure side wall. The tip wall is recessed from the first tip edge and the second tip edge to define a tip pocket having a suction side wall tip section and a pressure side wall tip section. At least one turbulator is formed in the tip pocket on at least one of the following: the tip wall, the suction side wall tip section, and the pressure side wall tip section. The at least one turbulator formed on the tip wall is selectively positioned.

### FIELD

The present disclosure relates to gas turbine engines, and more specifically, to turbine blades having turbulator-cooled tip pockets and methods for manufacturing the same.

### BACKGROUND

Conventional gas turbine engine blades frequently utilize squealer or semi-squealer type tip pockets. Reattachment flow comprising high velocity hot combustion gas swirls around and becomes trapped in and around the tip pocket of a gas turbine engine blade. This results in such tip pockets becoming oxidized or otherwise damaged during engine operation. While these tip pockets may include a number of cooling holes for circulating coolant, improved tip pocket cooling may reduce vortex strength, thereby reducing thermal load on the squealer and semi-squealer type tip pockets.

### SUMMARY

A turbine blade is provided in accordance with various embodiments. The turbine blade includes a suction side wall including a first tip edge and a pressure side wall opposite the suction side wall and including a second tip edge. A tip wall extends between the suction side wall and the pressure side wall. The tip wall is recessed from the first tip edge and the second tip edge to define a tip pocket having a suction side wall tip section and a pressure side wall tip section. At least one turbulator is formed in the tip pocket on at least one of the following: the tip wall, the suction side wall tip section, and the pressure side wall tip section. The at least one turbulator formed on the tip wall is selectively positioned thereon.

A turbine blade is provided in accordance with various embodiments. The turbine blade comprises a suction side wall including a first tip edge and a pressure side wall opposite the suction side wall and including a second tip edge. A tip wall extends between the suction side wall and the pressure side wall. The tip wall is recessed from the first tip edge and the second tip edge to define a tip pocket having a suction side wall tip section and a pressure side wall tip section. At least one turbulator is formed in the tip pocket and comprises a protrusion formed on an exposed surface of one or more of the tip wall, the suction side wall tip section, and the pressure side wall tip section. A plurality of cooling openings is formed through the tip wall and communicates with an internal cooling circuit in the turbine blade.

A turbine rotor is provided according to various embodiments. The turbine rotor comprises a rotor and a plurality of turbine blades extending radially outwardly from the rotor. At least one turbine blade of the plurality of turbine blades comprises a suction side wall including a first tip edge and a pressure side wall opposite the suction side wall and including a second tip edge. A tip wall extends between the suction side wall and the pressure side wall. The tip wall is recessed from the first tip edge and the second tip edge to define a tip pocket having a suction side wall tip section and a pressure side wall tip section. At least one turbulator is formed in the tip pocket on at least one of the tip wall, the suction side wall tip section, and the pressure side wall tip section. If formed on the tip wall, the at least one turbulator partially extends across the tip wall.

In any of the foregoing embodiments, the at least one turbulator is formed on the tip wall and at least partially extends between the suction side wall tip section and the pressure side wall tip section. The at least one turbulator comprises a rib turbulator. The at least one turbulator is formed to radially extend from at least one of the suction side wall tip section, or the pressure side wall tip section. The at least one turbulator is formed in a portion of the tip wall. The turbine blade further comprises an internal cooling circuit formed at least partially between the suction side wall, the pressure side wall, and the tip wall, the internal cooling circuit including at least one internal rib and the at least one turbulator is aligned with an internal rib of the at least one internal rib. A plurality of cooling openings is formed through the tip wall and fluidly communicates with the internal cooling circuit. The at least one turbulator in the tip wall is selectively positioned to provide a conduction path for heat to dissipate away from the tip wall, thereby cooling the tip pocket.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 is a schematic, cross-sectional view of a gas turbine engine according to various embodiments;

FIG. 2 is a perspective, side view of a turbine assembly of the gas turbine engine of FIG. 1, the turbine assembly including a turbine rotor according to various embodiments;

FIG. 3 is a perspective, pressure side view of a turbine blade in accordance with various embodiments;

FIG. 4 is a perspective, suction side view of the turbine blade of FIG. 3;

FIG. 5 is a close up view of a turbulator-cooled tip pocket of a turbine blade such as illustrated in FIGS. 3 and 4 according to various embodiments;

FIG. 6 is a close-up view of a turbulator-cooled tip pocket of a turbine blade such as illustrated in FIGS. 3 and 4 according to various embodiments;

FIG. 7 is a close-up view of a turbulator-cooled tip pocket of a turbine blade such as illustrated in FIGS. 3 and 4 according to various embodiments;

FIG. 8 is a schematic view taken along line 8-8 of FIG. 5 of an internal cooling circuit of the turbine blade; and

FIG. 9 is a schematic illustration of turbulent vortices that occur when hot combustion gas enters a tip pocket of a turbine blade.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with this invention and the teachings herein. Thus, the detailed description herein is presented for purposes of illustration only and not of limitation. The scope of the invention is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact. Furthermore, any reference to singular includes plural embodiments, and any reference to more than one component or step may include a singular embodiment or step.

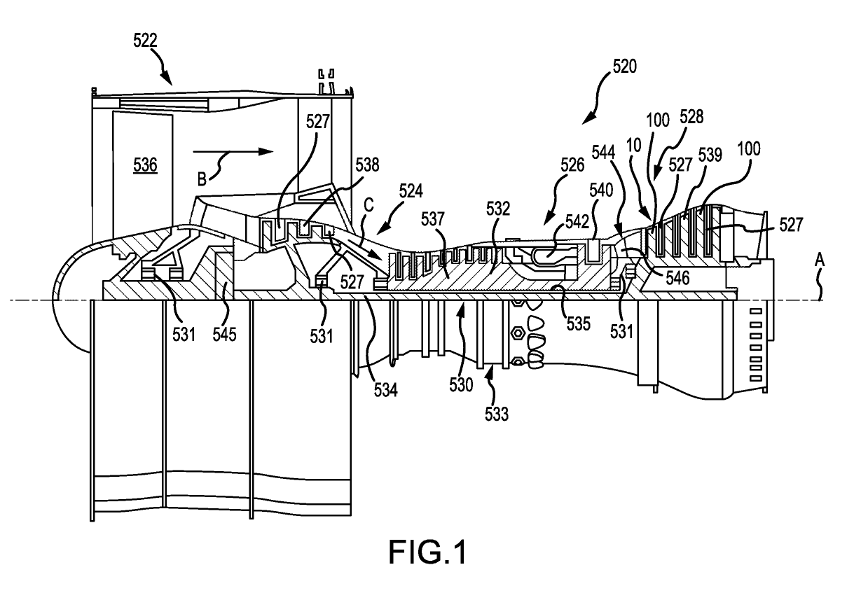

FIG. 1 schematically illustrates a gas turbine engine 520. The exemplary gas turbine engine 520 is a two-spool turbofan engine that generally incorporates a fan section 522, a compressor section 524, a combustor section 526 and a turbine section 528. Alternative engines might include an augmenter section (not shown) among other systems for features. The fan section 522 drives air along a bypass flow path B, while the compressor section 524 drives air along a core flow path C for compression and communication into the combustor section 526. The hot combustion gases generated in the combustor section 526 are expanded through the turbine section 528. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

The gas turbine engine 520 generally includes a low speed spool 530 and a high speed spool 532 mounted for rotation about an engine centerline longitudinal axis A. The low speed spool 530 and the high speed spool 532 may be mounted relative to an engine static structure 533 via several bearing systems 531. It should be understood that other bearing systems 531 may alternatively or additionally be provided.

The low speed spool 530 generally includes an inner shaft 534 that interconnects a fan 536, a low pressure compressor 538 and a low pressure turbine 539. The inner shaft 534 can be connected to the fan 536 through a geared architecture 545 to drive the fan 536 at a lower speed than the low speed spool 530. The high speed spool 532 includes an outer shaft 535 that interconnects a high pressure compressor 537 and a high pressure turbine 540. In this embodiment, the inner shaft 534 and the outer shaft 535 are supported at various axial locations by bearing systems 531 positioned within the engine static structure 533.

A combustor 542 is arranged between the high pressure compressor 537 and the high pressure turbine 540. A mid-turbine frame 544 may be arranged generally between the high pressure turbine 540 and the low pressure turbine 539. The mid-turbine frame 544 can support one or more bearing systems 531 of the turbine section 528. The mid-turbine frame 544 may include one or more airfoils 546 that extend within the core flow path C.

The inner shaft 534 and the outer shaft 535 are concentric and rotate via the bearing systems 531 about the engine centerline longitudinal axis A, which is co-linear with their longitudinal axes. The core airflow is compressed by the low pressure compressor 538 and the high pressure compressor 537, is mixed with fuel and burned in the combustor 542, and is then expanded over the high pressure turbine 540 and the low pressure turbine 539. The high pressure turbine 540 and the low pressure turbine 539 rotationally drive the respective high speed spool 532 and the low speed spool 530 in response to the expansion.

The pressure ratio of the low pressure turbine 539 can be pressure measured prior to the inlet of the low pressure turbine 539 as related to the pressure at the outlet of the low pressure turbine 539 and prior to an exhaust nozzle of the gas turbine engine 520. In one non-limiting embodiment, the bypass ratio of the gas turbine engine 520 is greater than about ten (10:1), the fan diameter is significantly larger than that of the low pressure compressor 538, and the low pressure turbine 539 has a pressure ratio that is greater than about five (5:1). It should be understood, however, that the above parameters are only exemplary of one embodiment of a geared architecture engine and that the present disclosure is applicable to other gas turbine engines, including direct drive turbofans.

In this embodiment of the exemplary gas turbine engine 520, a significant amount of thrust is provided by the bypass flow path B due to the high bypass ratio. The fan section 522 of the gas turbine engine 520 is designed for a particular flight condition—typically cruise at about 0.8 Mach and about 35,000 feet. This flight condition, with the gas turbine engine 520 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 522 without the use of a Fan Exit Guide Vane system. The low Fan Pressure Ratio according to one non-limiting embodiment of the example gas turbine engine 520 is less than 1.45. Low Corrected Fan Tip Speed is the actual fan tip speed divided by an industry standard temperature correction of [(Tram ° R)/(518.7° R)]^{0.5}, where T represents the ambient temperature in degrees Rankine. The Low Corrected Fan Tip Speed according to one non-limiting embodiment of the example gas turbine engine 520 is less than about 1150 fps (351 m/s).

Each of the compressor section 524 and the turbine section 528 may include alternating rows of rotor assemblies and vane assemblies (shown schematically) that carry airfoils that extend into the core flow path C. For example, the rotor assemblies in the turbine section 528 can carry a plurality of rotating blades 100, while each vane assembly can carry a plurality of vanes 527 that extend into the core flow path C. The blades 100 of the rotor assemblies in the turbine section create or extract energy (in the form of pressure) from the core airflow that is communicated through the gas turbine engine 520 along the core flow path C. The vanes 527 of the vane assemblies direct the core airflow to the blades 100 to either add or extract energy.

Various components of a gas turbine engine 520, including but not limited to the airfoils of the blades 100 and the vanes 527 of the compressor section 524 and the turbine section 528, may be subjected to repetitive thermal cycling under widely ranging temperatures and pressures. The hardware of the turbine section 528 is particularly subjected to relatively extreme operating conditions. Therefore, some components may require internal cooling circuits for cooling the parts during engine operation as hereinafter described.

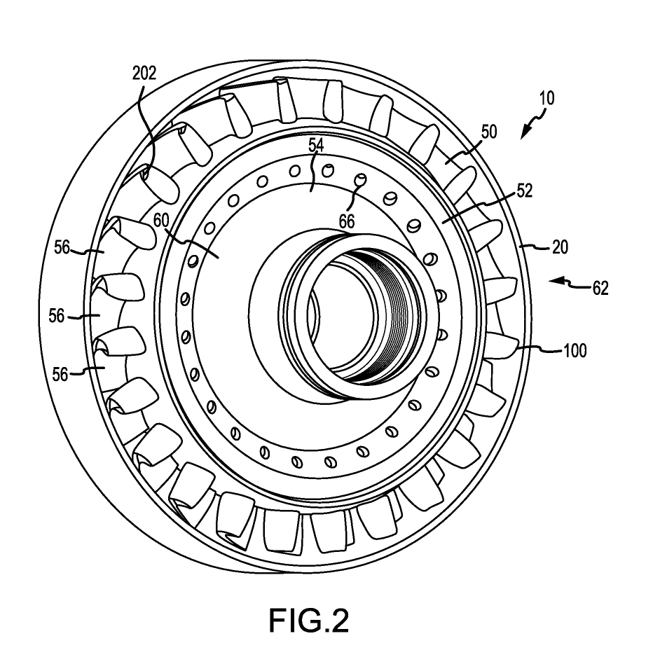

FIG. 2 is a perspective, side view of a turbine assembly 10 of the gas turbine engine 520 of FIG. 1. The turbine blade 100 having a turbulator-cooled tip pocket may be implemented in the turbine assembly 10, according to various embodiments. The turbine assembly 10 includes a blade outer air seal (BOAS) 20 surrounding the rotor assembly (also known herein as a turbine rotor 50). The BOAS 20, configured as a cylindrical shroud, is disposed concentric to the turbine rotor 50 to optimize aerodynamic efficiency and forms a radial gap (i.e., blade running clearance) with an outermost diameter of the turbine rotor. The turbine rotor 50 generally includes a blade ring 52, a turbine disk 54, and a plurality of the turbine blades 100. At least one turbine blade of the plurality of turbine blades of turbine rotor 50 may have a turbulator-cooled tip pocket.

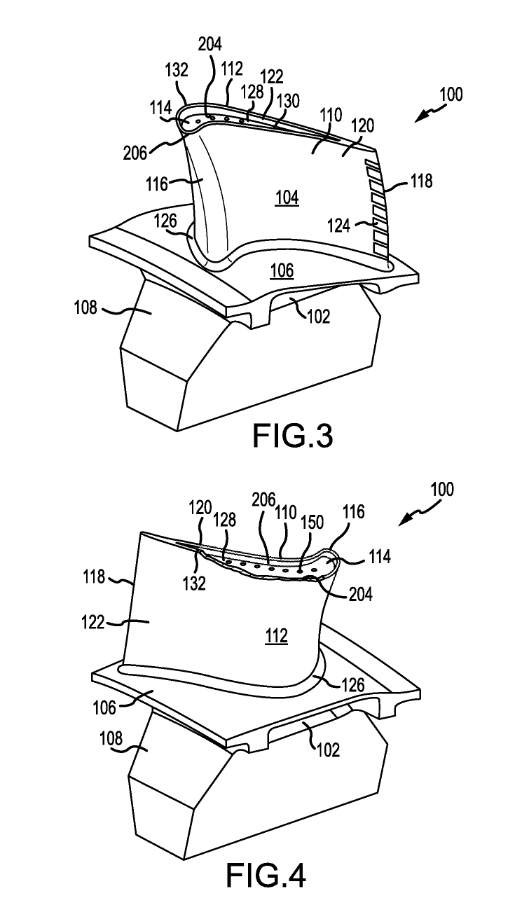

FIG. 3 is a perspective, pressure side view of a turbine blade 100 of the plurality of turbine blades and FIG. 4 is a perspective, suction side view of the turbine blade of FIG. 3. The turbine blade 100 may include a shank 102, an airfoil 104, a platform 106, and a root 108. The platform 106 is configured to radially contain turbine airflow. The root 108 is used to attach the turbine blade 100 to a turbine rotor disk. The root 108 may be machined into any one of numerous other shapes suitable for attaching the turbine blade 100 to the turbine disk 54 (FIG. 2). For example, the root 108 may include a firtree machined therein.

The airfoil 104 is made up of a pressure side wall 110, a suction side wall 112 opposite the pressure side wall 110, and a tip wall 114 extending between and coupling the pressure side wall 110 and the suction side wall 112 together. Generally, the pressure side wall 110 is concave and the suction side wall 112 is convex. The walls 110, 112, 114 have outer surfaces that together define an airfoil shape. The airfoil shape comprises a leading edge 116, a trailing edge 118, a pressure side 120 along the pressure side wall 110, a suction side 122 along the suction side wall 112, one or more trailing edge slots 124, an airfoil platform fillet 126, and a tip pocket 128. The tip pocket 128 is defined by inwardly facing outer surfaces of the side walls 110, 112 and the tip wall 114, which is recessed from tip edges 130, 132 of the side walls 110, 112. The inwardly facing outer surfaces of the side walls 110, 112 comprise the sidewalls of the tip pocket and are referred to herein as a suction side wall tip section 204 and a pressure side wall tip section 206. To cool the tip region of the turbine blade 100, the tip pocket 128 and cooling openings 150 may be included therein.

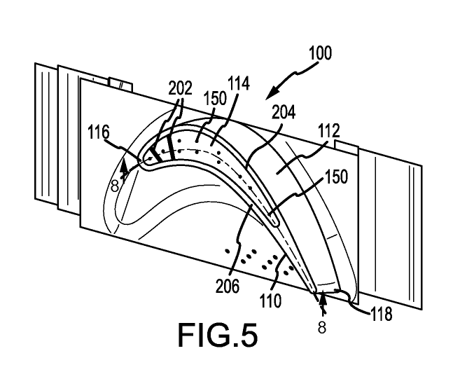

FIGS. 5 through 7 are close up views of the tip region of a turbine blade such as turbine blade 100, according to various embodiments. According to various embodiments, the tip pocket 128 includes at least one turbulator 202 formed on an exposed surface of the tip pocket. Therefore, the at least one turbulator 202 may be formed on the inwardly facing outer surfaces (i.e., the suction side wall tip section 204 and the pressure side wall tip section 206) of the side walls 110, 112, the tip wall 114, or combinations thereof, i.e., the at least one turbulator 202 may be formed in the tip pocket 128 on one or more of the tip wall 114, the suction side wall tip section 204, and the pressure side wall tip section 206.

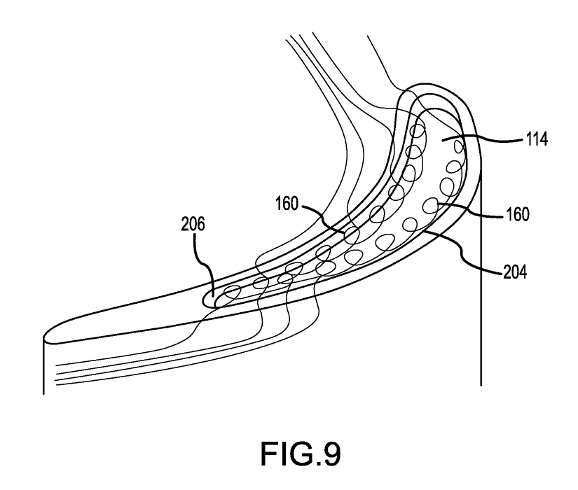

FIG. 9 illustrates turbulent vortices 160 that occur when combustion gas enters the tip pocket 128. The vortices enter the tip pocket 128 and travel aft along the inward facing surfaces of the pressure and suction side wall tip sections, 206 and 204 respectively, to the lowest sink pressures, increasing in velocity and strength. This causes high heat transfer coefficients that scrub and heat up the suction side wall tip section 204 and the pressure side wall tip section 206. Introducing turbulators 202 on the tip wall 114 and/or inward facing surfaces of the suction side wall tip section 204 and/or the pressure side wall tip section 206 reduces the strength and velocity of the vortices 160 and thereby reduces the heat transfer coefficients and metal temperatures on these walls/wall tip sections. The turbulator(s) formed on the tip wall are selectively positioned to provide a conduction path for heat to dissipate away from the tip wall, thereby cooling the tip pocket, as hereinafter described.

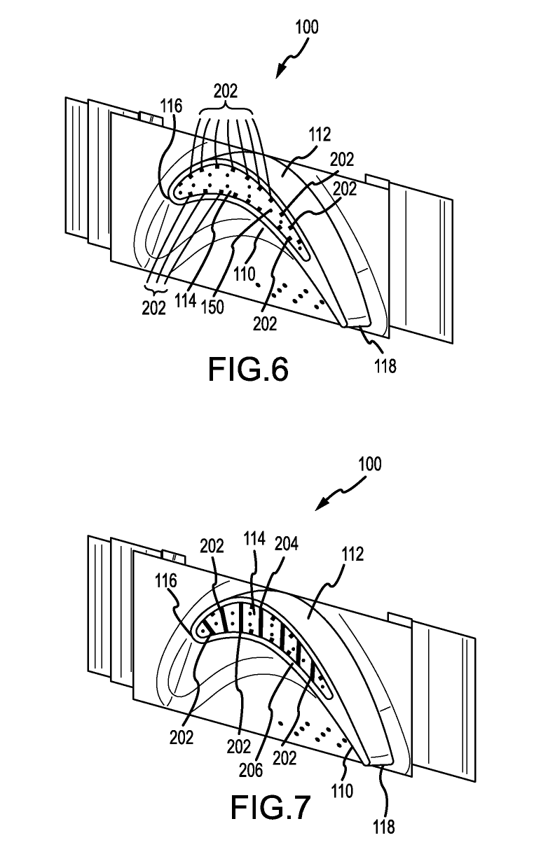

Referring now specifically to FIG. 5, according to various embodiments, a pair of turbulators 202 (for example, rib turbulators) are depicted as formed in the tip wall 114 and extending between the suction side wall tip section 204 and the pressure side wall tip section 206 near the leading edge of the turbine blade 100. FIG. 6, according to various embodiments, depicts a plurality of turbulators radially extending on each of the suction side wall tip section 204 and the pressure side wall tip section 206 from leading edge to trailing edge. FIG. 7, according to various embodiments, depicts a plurality of turbulators formed on both the tip wall 114 and the suction side wall tip section 204 and the pressure side wall tip section 206.

Although FIGS. 5 through 7 depict the at least one turbulator in various embodiments as being located in particular positions in the tip pocket, it is to be understood that the at least one turbulator may be located in other positions in the tip pocket. Similarly, the at least one turbulator 202 may be in various forms. According to various embodiments, a turbulator 202 comprises a protrusion that is placed in the tip pocket 128 of the turbine blade 100 in order to reduce heat transfer coefficients by reducing the strength and velocity of the tip vortices 160. Various embodiments include at least one turbulator comprising a protrusion in the form of a rib, a bump, etc. (shown schematically in FIGS. 5 through 7). More particularly, such turbulator characteristics as the orientation, number, height, length, width, spacing, shape, angle thereof may vary. The size of the at least one turbulator and the distance between two successive turbulators and the pitch (i.e., the steepness) of the turbulator may vary and affect heat transfer around the tip pocket. The heat transfer performance of the at least one turbulator also depends on the turbulator aspect ratio, turbulator configuration, spacing, etc. While the turbulators of FIGS. 5 and 7 are depicted as extending the entire distance between the suction side wall tip section and the pressure side wall tip section, it is to be understood that the at least one turbulator may extend partially between the suction side wall tip section and the pressure side wall tip section as well as at least partially extend between the leading edge and the trailing edge.

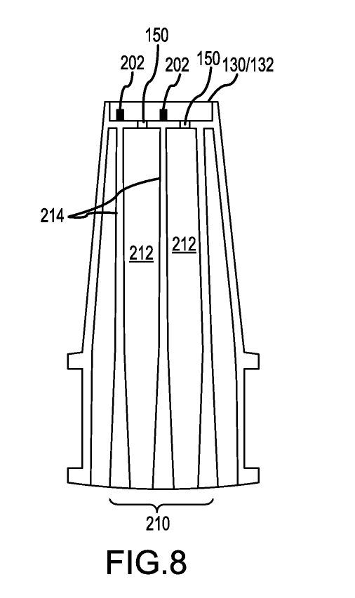

As noted previously and as depicted in FIGS. 5 through 7, the turbine blade 100 may include cooling openings 150 in the tip wall. The cooling openings extend from an outer (exposed) surface of the tip wall 114 to an internal cooling circuit 210 (shown schematically in FIG. 8) of the turbine blade 100, i.e., the cooling openings communicating with cavities 212 or cooling channels of the internal cooling circuit. The internal cooling circuit is formed at least particularly between the suction side wall, the pressure side wall, and the tip wall. The internal cooling circuit 210 is configured to cool the pressure side wall 110, suction side wall 112, and tip wall 114. To do so, the internal cooling circuit 210 may comprise one or more cavities 212 formed by the inner surfaces of the pressure side wall 110, suction side wall 112, and tip wall 114. One or more internal ribs 214 may separate the one or more cavities 212 of the internal cooling circuit into separate flow circuits that may or may not be in flow communication with each other. In various embodiments, as depicted in FIG. 8, the turbulators 202 may be manufactured as extensions of the internal ribs 214 (i.e., vertically aligned with the internal ribs (i.e., selectively positioned)), easing manufacture of the overall turbine blade and providing a conduction path for the heat to dissipate away from the tip wall 114 into the internal ribs 214, thereby cooling the tip pocket 128.

Turbine blades having turbulator-cooled tip pockets and methods for manufacturing the same have been described. The turbulator-cooled tip pockets reduce vortex strength and thermal load in and around the tip pocket, thereby reducing oxidation and other damage to the tip pocket during engine operation.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A turbine blade, comprising:
a suction side wall including a first tip edge;
a pressure side wall opposite the suction side wall and including a second tip edge;
a tip wall extending between the suction side wall and the pressure side wall, the tip wall recessed from the first tip edge and the second tip edge to define a tip pocket having a suction side wall tip section and a pressure side wall tip section; and
at least one turbulator formed in the tip pocket on at least one of the following: the tip wall, the suction side wall tip section, and the pressure side wall tip section, wherein the at least one turbulator formed on the tip wall is selectively positioned thereon.

2. The turbine blade of claim 1, wherein the at least one turbulator is formed on inwardly facing outer surfaces of the suction side wall tip section, of the pressure side wall tip section, or both.

3. The turbine blade of claim 1, wherein the at least one turbulator is formed on a portion of the tip wall.

4. The turbine blade of claim 3, wherein the at least one turbulator is formed on the tip wall and partially extends between the suction side wall tip section and the pressure side wall tip section.

5. The turbine blade of claim 1, wherein the at least one turbulator comprises a rib turbulator.

6. The turbine blade of claim 1, wherein the at least one turbulator is formed to radially extend from at least one of the suction side wall tip section or the pressure side wall tip section.

7. The turbine blade of claim 1, further comprising an internal cooling circuit formed at least partially between the suction side wall, the pressure side wall, and the tip wall, the internal cooling circuit including at least one internal rib and the at least one turbulator in the tip wall is aligned with an internal rib of the at least one internal rib.

8. The turbine blade of claim 7, wherein a plurality of cooling openings are formed through the tip wall and fluidly communicate with the internal cooling circuit.

9. A turbine blade, comprising:
a suction side wall including a first tip edge;
a pressure side wall opposite the suction side wall and including a second tip edge;
a tip wall extending between the suction side wall and the pressure side wall, the tip wall recessed from the first tip edge and the second tip edge to define a tip pocket having a suction side wall tip section and a pressure side wall tip section;
at least one turbulator formed in the tip pocket and comprising a protrusion formed on an exposed surface of one or more of the tip wall, the suction side wall tip section, and the pressure side wall tip section; and
a plurality of cooling openings formed through the tip wall and communicating with an internal cooling circuit in the turbine blade.

10. The turbine blade of claim 9, wherein the at least one turbulator is formed on a portion of the tip wall.

11. The turbine blade of claim 10, wherein the at least one turbulator is formed on the tip wall and partially extends between the suction side wall tip section and the pressure side wall tip section.

12. The turbine blade of claim 9, wherein the at least one turbulator comprises a rib turbulator.

13. The turbine blade of claim 9, wherein the at least one turbulator is formed to radially extend on the suction side wall tip section, the pressure side wall tip section, or both.

14. The turbine blade of claim 9, wherein the internal cooling circuit is formed at least partially between the suction side wall, the pressure side wall, and the tip wall, the internal cooling circuit including at least one internal rib and the at least one turbulator is aligned with an internal rib of the at least one internal rib.

15. A turbine rotor comprising:
a rotor;
a plurality of turbine blades extending radially outwardly from the rotor, at least one turbine blade of the plurality of turbine blades comprising:
a suction side wall including a first tip edge;
a pressure side wall opposite the suction side wall and including a second tip edge;
a tip wall extending between the suction side wall and the pressure side wall, the tip wall recessed from the first tip edge and the second tip edge to define a tip pocket having a suction side wall tip section and a pressure side wall tip section; and
at least one turbulator formed in the tip pocket, wherein the at least one turbulator is formed on one or more of the tip wall, the suction side wall tip section, and the pressure side wall tip section and if formed on the tip wall, the at least one turbulator partially extends across the tip wall.

16. The turbine rotor of claim 15, wherein the at least one turbulator is selectively positioned on the tip wall to provide a conduction path for heat to dissipate away from the tip wall, thereby cooling the tip pocket.

17. The turbine rotor of claim 15, wherein the at least one turbulator is formed in a portion of the tip wall.

18. The turbine rotor of claim 17, wherein the at least one turbulator is formed on the tip wall and partially extends between the suction side wall tip section and the pressure side wall tip section.

19. The turbine rotor of claim 15, wherein the at least one turbulator is formed to radially extend on the suction side wall tip section, the pressure side wall tip section, or both.

20. The turbine rotor of claim 15, further comprising an internal cooling circuit formed at least partially between the suction side wall, the pressure side wall, and the tip wall, the internal cooling circuit including at least one internal rib and the at least one turbulator is aligned with an internal rib of the at least one internal rib.
